(19) United States
(12) Patent Application Publication
(10) Pub. No.: US 2013/0277946 A1
(43) Pub. Date: Oct. 24, 2013

(54) HITCH BUSHING

(71) Applicant: POWER PIN INC., Fort Qu'Appelle Saskatchewan (CA)

(72) Inventor: Brian R. Olson, Fort Qu'Appelle Saskatchewan (CA)

(73) Assignee: POWER PIN INC., Fort Qu'Appelle Saskatchewan (CA)

(21) Appl. No.: 13/755,965

(22) Filed: Jan. 31, 2013

(30) Foreign Application Priority Data
Apr. 19, 2012 (CA) 2774519

(51) Int. Cl. B60D 1/58

(52) U.S. Cl. CPC B60D 1/58
USPC 280/515

(57) ABSTRACT

A hitch apparatus has a tongue member with a weight bearing surface and an opposite free surface, and defining a bushing hole extending substantially vertically. A bushing has a cylindrical portion defining a drawpin hole with an outside diameter equal to an inside diameter of the bushing hole and a flange extending outward from one end of the cylindrical portion. The flange has a tongue surface adjacent to the cylindrical portion of the bushing, and an opposite wearing surface. The cylindrical portion of the bushing extends into the bushing hole such that the tongue surface of the flange bears against the weight bearing surface of the tongue member, and the bushing has a Rockwell Scale hardness greater than a Rockwell Scale hardness of the tongue member. Different bushings may define a variety of drawpin hole diameters to suit different drawpins.

This invention is in the field of agricultural implements and in particular a hitch apparatus for connecting an implement to a towing tractor.

### BACKGROUND

An agricultural implement is typically connected to a tractor drawbar by a clevis and tongue connection. The clevis provides upper and lower clevis members each defining a draw pin hole, and the tongue defines a draw pin hole and is inserted between the clevis members to align the draw pin holes such that a draw pin can be inserted through them and thereby connect the clevis and tongue.

The clevis is formed by attaching a hammer strap to either the tractor drawbar or the implement hitch and providing a recess between the hammer strap and drawbar or implement hitch for receiving the tongue. In either event, the tractor drawbar must support the weight of the front end of the implement being towed, which can be considerable. Thus the tongue of the implement hitch must be connected to the drawbar so that the implement tongue is above and resting on the drawbar. Thus where the hammer strap is mounted to the tractor drawbar, the hammer strap is above the drawbar and the implement hitch tongue rests on the drawbar, and where the hammer strap is mounted to the implement hitch tongue, the hammer strap is under the implement hitch tongue, and again the implement hitch tongue rests on the drawbar.

A predominant area of wear on an implement hitch tongue is the front surface of the draw pin hole. It is this surface against which the draw pin bears when exerting the draft force necessary to pull the implement in the operating travel direction, and thus where full load is placed on the draw pin. Also the bottom of the implement hitch tongue rests on the tractor drawbar, often with considerable downward force. As the tractor and implement turn and pivot about the vertical draw pin, the bottom of the implement hitch tongue wears against the top of the tractor drawbar, and the drawpin wears against the front surface of the drawpin hole. As tractor and implement widths have increased, draft forces necessary to pull the implement, and in many cases implement hitch tongue weight as well, have increased significantly, with a corresponding increase in hitch wear. With some implements, such as tub grinders, bale processors, grain carts and the like, while the draft forces are not excessive, tongue weight is significant and in operation the tractor and implement are constantly turning, such that wear on the bottom weight bearing surface of the tongue is pronounced.

Implement hitch tongues are typically made from ductile or nodular cast iron, which is inexpensive and resists cracking, as opposed to more wear resistant materials which are brittle. It is known to austemper these cast iron implement hitch tongues to resist this wear, and prolong their useful life, however such tempering significantly increases the cost of the implement hitch tongues, and Rockwell Scale hardness can only be increased from about HRC 21 hardness to about HRC 43. Similarly for increased wear resistance, implement hitch tongues can be made from cast steel, however this also significantly increases the cost.

Tractors come in a wide variety of sizes, and the drawpin hole is typically sized for a drawpin of sufficient strength to match the power of the tractor. Implements also come in a wide variety, and similarly have a hitch with a drawpin hole that is sized for a drawpin of sufficient strength to match the power requirement of the implement. Since there are typically a limited number of tractors on a farm that are required to tow a wide variety of implements, often the drawpin holes are of different sizes, and a drawpin that fits through the smaller of the holes must be used. The implement and tractor are thus connected by a loose fitting connection that allows significant movement. Control of the implement is thus reduced, and undesirable shock forces are exerted on the draw pin, implement hitch, and tractor drawbar during use, causing excessive wear.

### SUMMARY OF THE INVENTION

It is an object of the present invention to provide a hitch apparatus that overcomes problems in the prior art.

In a first embodiment the present invention provides a hitch apparatus comprising a tongue member with a weight bearing surface and a free surface opposite the weight bearing surface, and defining a bushing hole extending substantially vertically therethrough from the weight bearing surface to the free surface. A bushing comprises a cylindrical portion defining a drawpin hole therethrough and having an outside diameter substantially equal to an inside diameter of the bushing hole and a flange extending outward from one end of the cylindrical portion, the flange comprising a tongue surface adjacent to the cylindrical portion of the bushing, and an opposite wearing surface. The cylindrical portion of the bushing extends into the bushing hole such that the tongue surface of the flange bears against the weight bearing surface of the tongue member, and the bushing has a Rockwell Scale hardness greater than a Rockwell Scale hardness of the tongue member.

In a second embodiment the present invention provides an implement hitch apparatus adapted at a rear end thereof for attachment to an implement to be towed in an operating travel direction. The apparatus comprises a hitch tongue member defining a hitch bushing hole extending substantially vertically through a front portion thereof. A hitch bushing comprises a cylindrical portion defining a drawpin hole therethrough and having an outside diameter substantially equal to an inside diameter of the hitch bushing hole and a hitch flange extending outward from a bottom edge of the cylindrical portion. The cylindrical portion of the hitch bushing extends upward into the hitch bushing hole and a top surface of the hitch flange bears against a bottom surface of hitch tongue member, and the hitch bushing has a Rockwell Scale hardness greater than a Rockwell Scale hardness of the hitch tongue member.

In a third embodiment the present invention provides a hitch apparatus comprising a tongue member defining a main drawpin hole extending substantially vertically therethrough. A recess is defined in a top surface of the tongue member adjacent to the main drawpin hole. A bushing comprises a cylindrical portion defining a reduced drawpin hole therethrough and having an outside diameter substantially equal to an inside diameter of the main drawpin hole and a flange portion extending outward from a top end of the cylindrical portion, and the bushing is inserted into the bushing hole and the flange portion substantially fills the recess.

A connected tractor drawbar and implement hitch assembly configured for towing the implement with the tractor in an operating travel direction comprises a similarly configured drawbar member oriented upside down compared to the hitch tongue member. The drawbar member is attached at a front end thereof to a tractor and defines a drawbar bushing hole extending substantially vertically through a rear portion thereof, and a drawbar bushing comprises a cylindrical portion defining a drawpin hole therethrough and having an outside diameter substantially equal to an inside diameter of the drawbar bushing hole and a drawbar flange extending outward from a top edge of the cylindrical portion. The cylindrical portion of the drawbar bushing extends downward into the drawbar bushing hole and a bottom surface of the drawbar flange bears against a top surface of drawbar member. The hitch tongue member is supported on the drawbar member with a bottom surface of the hitch flange bearing against a top surface of the drawbar flange, and a drawpin extends downward through the drawpin holes.

The bushing is of a harder material than the tongue member, and so wear on the inside surface of the drawpin holes and on the weight bearing surface of the tongue members is significantly reduced. The bushing will typically also be harder than the drawpin, such that the more easily replaced drawpin will wear before the bushing.

Bushings can also be inserted into drawbar or hitch tongue holes to change the diameter of the drawpin hole to suit different drawpins.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a top view of an embodiment of a hitch apparatus of the present invention;

FIG. 2 is a schematic sectional side view of the embodiment of FIG. 1 oriented with the wearing surface of the bushing facing down, as it would be where the tongue member is an implement hitch;

FIG. 3 is a bottom view of the embodiment of FIG. 1;

FIG. 4 is a schematic sectional side view of the embodiment of FIG. 1 oriented with the wearing surface of the bushing facing up, as it would be where the tongue member is a tractor drawbar;

FIGS. 5 and 6 are perspective views of opposite sides of the bushing of FIG. 1;

FIG. 7 is a side view of a connected tractor drawbar and implement hitch assembly with a first embodiment of FIG. 1 oriented as in FIG. 2 and attached to an implement, and supported on a second embodiment of FIG. 1 oriented as in FIG. 4 and attached to a tractor, where the first and second embodiments are connected by a drawpin through the drawpin holes;

FIG. 8 is a perspective top view of a embodiment of the present invention that is configured as an implement hitch;

FIG. 9 is a perspective bottom view of the embodiment of FIG. 8;

FIG. 10 is a perspective bottom view of the embodiment of FIG. 8 with the bushing removed to illustrate the recess that the flange sits in;

FIG. 11 is a schematic sectional side view of an embodiment of a hitch apparatus of the present invention for changing the size of the drawpin hole in a hitch tongue member, including a hammer strap, where the bushing is inserted in the main drawpin hole in the tongue member and a first drawpin extends through the aligned holes in the hammer strap and bushing;

FIG. 12 is a schematic sectional side view of the embodiment of FIG. 11 where the bushing is removed and a second drawpin extends through the aligned holes in the hammer strap and tongue member;

FIGS. 13 and 14 are schematic sectional views of an embodiment of a hitch apparatus of the present invention for changing the size of the drawpin hole in a hitch tongue member, where the recess and flanges have square corners;

FIGS. 15 and 16 are schematic sectional views of an embodiment of a hitch apparatus of the present invention for changing the size of the drawpin hole in a hitch tongue member, where the recess and flanges have rounded corners for guiding a drawpin;

FIG. 17 is a schematic top view showing an embodiment of a hitch apparatus of the present invention for changing the size of the drawpin hole in a hitch tongue member, where the recess and flanges are circular and concentric with the drawpin hole of the inserted bushing such that the bushing is rotatable in the bushing hole;

FIG. 18 is a schematic top view showing an embodiment of a hitch apparatus of the present invention for changing the size of the drawpin hole in a hitch tongue member, where the flanges engage the recess and prevent the bushing from rotating in the bushing hole.

### DETAILED DESCRIPTION OF THE ILLUSTRATED EMBODIMENTS

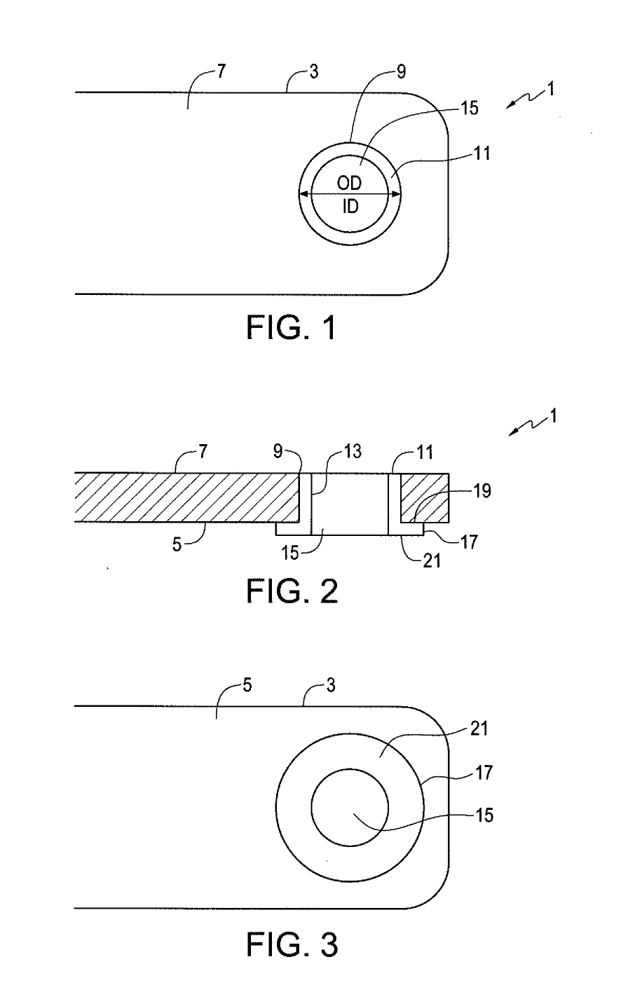

FIGS. 1-3 illustrate an embodiment of a hitch apparatus 1 of the present invention. The hitch apparatus 1 comprises a tongue member 3 with a weight bearing surface 5 and a free surface 7 opposite the weight bearing surface 5, and defining a bushing hole 9 extending substantially vertically therethrough from the weight bearing surface 5 to the free surface 7. The upward and downward orientation of the weight bearing surface 5 and free surface 7 will depend on whether the tongue member 3 is connected to the implement or the towing tractor. A tongue member 3 attached to an implement must rest on the top surface of the drawbar so the weight of the implement hitch is supported on the tractor drawbar and the weight bearing surface 5 of the tongue member 3 is the bottom surface. Similarly a tongue member 3 attached to a tractor as a drawbar must support the weight of the implement hitch and so the weight bearing surface 5 of the tongue member 3 is the top surface.

A bushing 11 is illustrated in FIGS. 5 and 6 and comprises a cylindrical portion 13 defining a drawpin hole 15 therethrough and having an outside diameter OD substantially equal to an inside diameter ID of the bushing hole 9. A flange 17 extends outward from one end of the cylindrical portion 13, the flange 17 comprising a tongue surface 19 adjacent to the cylindrical portion 13 of the bushing 11, and an opposite wearing surface 21. The cylindrical portion 13 of the bushing 11 extends into the bushing hole 9 such that the tongue surface 19 of the flange 17 bears against the weight bearing surface 5 of the tongue member 3.

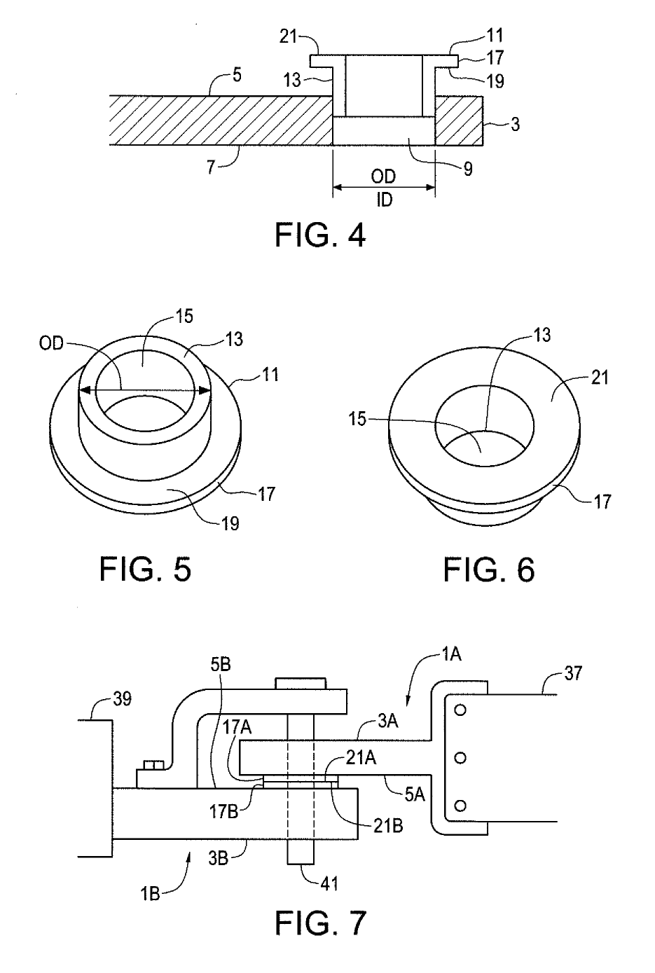

In FIGS. 1-3 the tongue member 3 is oriented as it would be for attachment to an implement, with the tongue surface 19 of the flange 17 bearing against the bottom weight bearing surface 5 of the tongue member 3. FIG. 4 illustrates the tongue member 3 oriented as it would be for attachment to a tractor as a drawbar, with the tongue surface 19 of the flange 17 bearing against the top weight bearing surface 5 of the tongue member 3.

Also in FIG. 4, the bushing 11 is shown only partially inserted into the bushing hole 9. It can be seen that, in either orientation, during use the vertical forces exerted on the bushing 11 by the weight of the implement urge the flange 17 against the tongue member 3 so the bushing cannot come out of the bushing hole. The bushing 11 may be installed in the bushing hole 9 by heating the tongue member 3 to expand the bushing hole slightly, inserting the bushing 11, and then allowing the assembly to cool shrinking the tongue member 3 onto the bushing 11. It is also contemplated that a small weld, adhesive, or like means could be used to keep the bushing 11 in the bushing hole 9 when not in use.

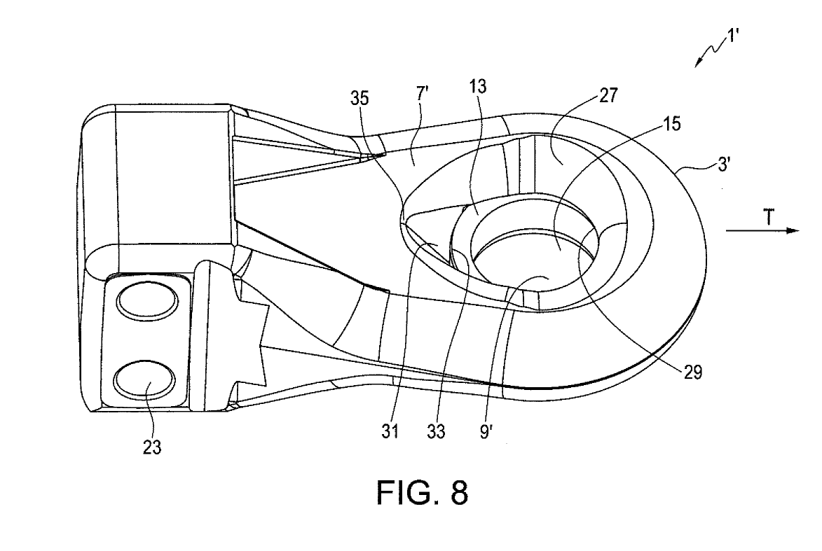

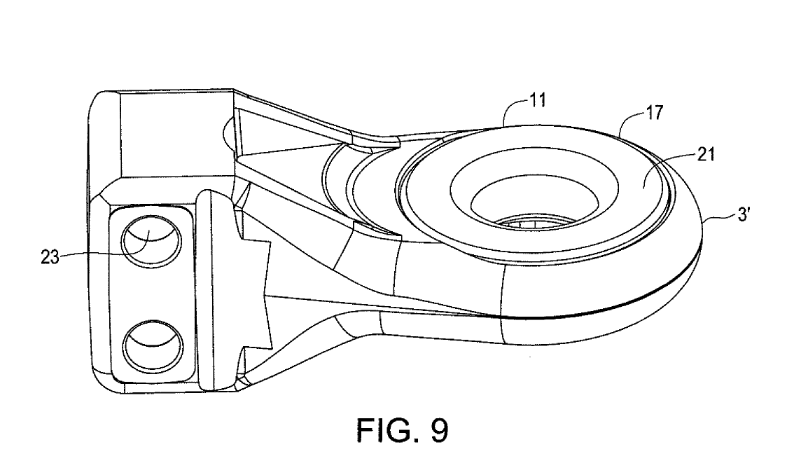

FIGS. 8 and 9 illustrate top and bottom views of an embodiment of a hitch apparatus 1′ of the present invention where the tongue member is an implement hitch tongue 3′ adapted at a rear end thereof for attachment by bolts through holes 23 to an implement to be towed in an operating travel direction T. The flange 17 is the same as that illustrated in FIGS. 5 and 6. The cylindrical portion 13 of the bushing 11 extends upward into the bushing hole 9′. FIG. 10 illustrates a bottom view of the hitch tongue 3′ with the bushing removed showing a recess 25 around the bushing hole 9′. The flange 17 fits in the recess 25 so that the top tongue surface 19 of the flange 17 bears against the bottom weight bearing surface 5′ of the hitch tongue inside the recess 25, and the wearing surface 21 of the flange 17 faces downward.

In the hitch tongue 3′, a sloping top portion 27 of the bushing hole 9′ slopes inward and downward from the top free surface 7′ of the hitch tongue 3′. The front portion 29 of the bottom edge of the sloping top portion 27 of the bushing hole 9′ aligns with the edge of the drawpin hole 15 in the bushing 11. In the illustrated apparatus 1′ the sloping top portion 27 of the bushing hole 9′ is also curved, and the shape of the top part of the bushing hole 9′ thus serves to guide a drawpin into the drawpin hole 15.

The illustrated hitch tongue 3′ further also defines a tapered groove 31 extending from a rear bottom edge 33 of the sloping top portion 27 of the bushing hole 9′ rearward and upward to a top edge 35 of the groove 31 at the top free surface 7′ of the tongue member 3′. The bottom portion of the tapered groove 31 is wider than the top portion thereof, and further serves to help guide a drawpin into the drawpin hole 15.

A connected hitch assembly 101 is shown in FIG. 7 comprising first and second hitch apparatuses 1A, 1B as shown in FIGS. 1-4, where the wearing surface 21A of the flange 17A of the first hitch apparatus 1A bears against the wearing surface 21B of the second hitch apparatus 21B.

The tongue member of the first apparatus 1A is an implement hitch tongue 3A adapted at a rear end thereof for attachment to an implement 37 to be towed in an operating travel direction T and is oriented as in FIGS. 1-3, where the cylindrical portion of the bushing extends upward into the bushing hole in the tongue member 3A, a top tongue surface of the hitch flange 17A bears against a bottom weight bearing surface 5A of the tongue member 3A, and the wearing surface 21A of the hitch flange 17A faces downward.

The tongue member of the second apparatus 1B is a tractor drawbar 3B adapted at a forward end thereof for attachment to a tractor 39 for towing the implement 37 in the operating travel direction T, where the cylindrical portion of the bushing extends downward into the bushing hole in the tongue member 3B, a bottom tongue surface of the drawbar flange 17B bears against a top weight bearing surface 5B of the tongue member 3B, and the wearing surface 21B of the drawbar flange 17B faces upward.

Thus the wearing surface 21A of the hitch flange 17A of the implement hitch tongue 3A rests on the wearing surface 21B of the drawbar flange 17B of the tractor drawbar 3B and a drawpin 41 extends through the drawpin holes of the flanges 17A, 17B.

The tongue member 3 is typically made from nodular cast iron with a Rockwell Scale hardness of about HRC 21. The bushing 11 will have a Rockwell Scale hardness greater than the Rockwell Scale hardness of the tongue members, and in most cases it is contemplated that the Rockwell Scale hardness of the bushings will be greater than about 60, thus significantly reducing the wear on the weight bearing surface 5 of the tongue member 3 that is protected by the bushing 11. The drawpin 41 will typically have a hardness of about HRC 53 so that the drawpin 41 will wear before the bushing 11, such that the less expensive drawpin 41 will be replaced rather than the bushing 11.

A film of grease between the bottom wearing surface 21A of the hitch flange 17A and the top wearing surface 21B of the drawbar flange further reduces friction and wear.

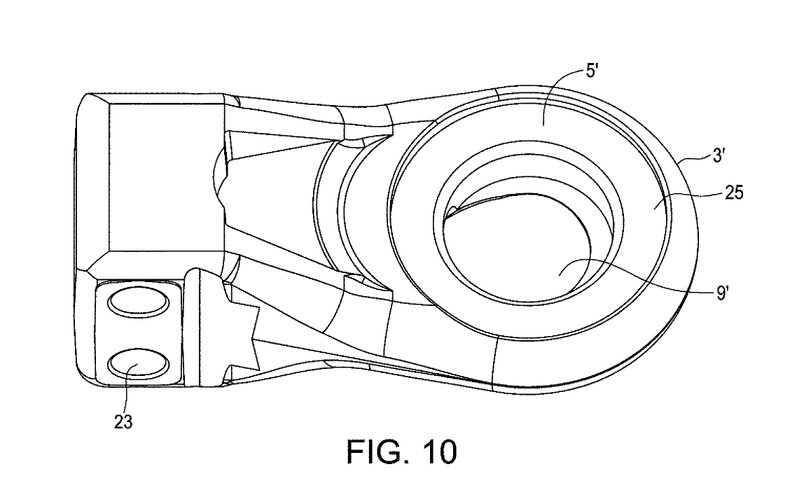

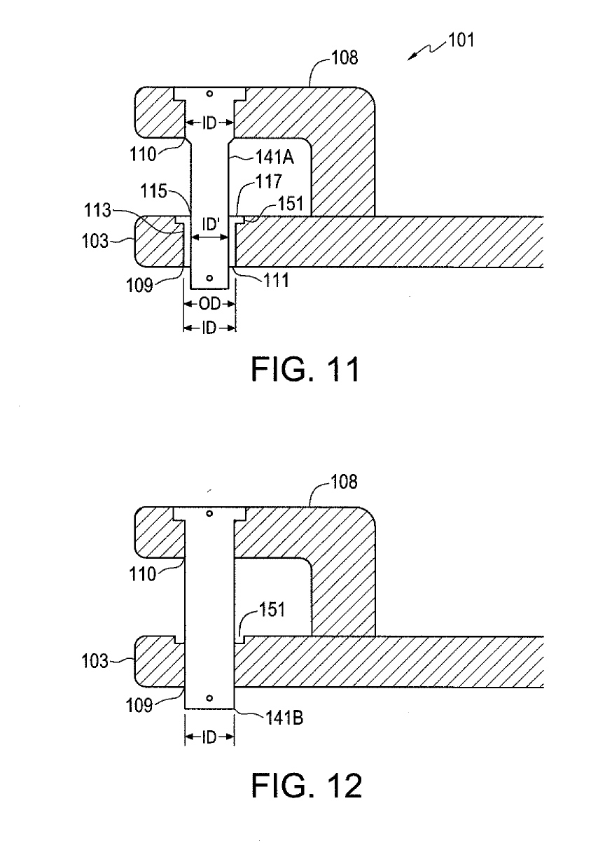

FIGS. 11 and 12 schematically illustrate a hitch apparatus 101 for adapting the hole in a tongue member 103 to accommodate different sizes of drawpins. The apparatus 101 comprises a tongue member 103 defining a main drawpin hole 109 extending substantially vertically therethrough. The main drawpin hole 109 is provided in a typical application by the conventional drawpin hole in a tongue member 103 provided by a tractor drawbar as illustrated complete with a hammer strap 108, or could also be an implement hitch tongue. The strap hole 110 through the hammer strap 108 has an inside diameter ID the same as the inside diameter ID of the main drawpin hole 109.

A recess 151 is defined in the top surface of the tongue member 103 adjacent to the main drawpin hole 109. A bushing 111 comprises a cylindrical portion 113 defining a reduced drawpin hole 115 therethrough with a smaller inside diameter ID′ and having an outside diameter OD substantially equal to the inside diameter ID of the main drawpin hole 109 and a flange portion 117 extending outward from a top end of the cylindrical portion 113.

FIG. 11 shows the bushing 111 inserted into the main drawpin hole 109, with the flange portion 117 substantially filling the recess 151 and keeping the bushing 111 from falling through the main drawpin hole 109. A first drawpin 141A with an upper portion having an outside diameter equal to the inside diameter ID of the strap hole 110, and a lower portion extending through the gap between the bottom of the hammer strap 108 and the top of the tongue member 103 that has a reduced diameter equal to the inside diameter ID′ of the reduced drawpin hole 115. The drawpin 141A fits through the hole in an implement hitch tongue that is smaller than the main drawpin hole 109 and fits the hole in the tongue member 103 now provided by the reduced drawpin hole 115 and the strap hole 110 in the hammer strap 109 snuggly with little room for movement and wear.

FIG. 12 shows the bushing 111 removed from the main drawpin hole 109. A second drawpin 141B with a consistent outside diameter the length thereof that is substantially equal to the inside diameter ID of the strap hole 110 and the main drawpin hole 109. The drawpin 141B fits through the hole in an implement hitch tongue that is the same as the main drawpin hole 109 and the strap hole 110.

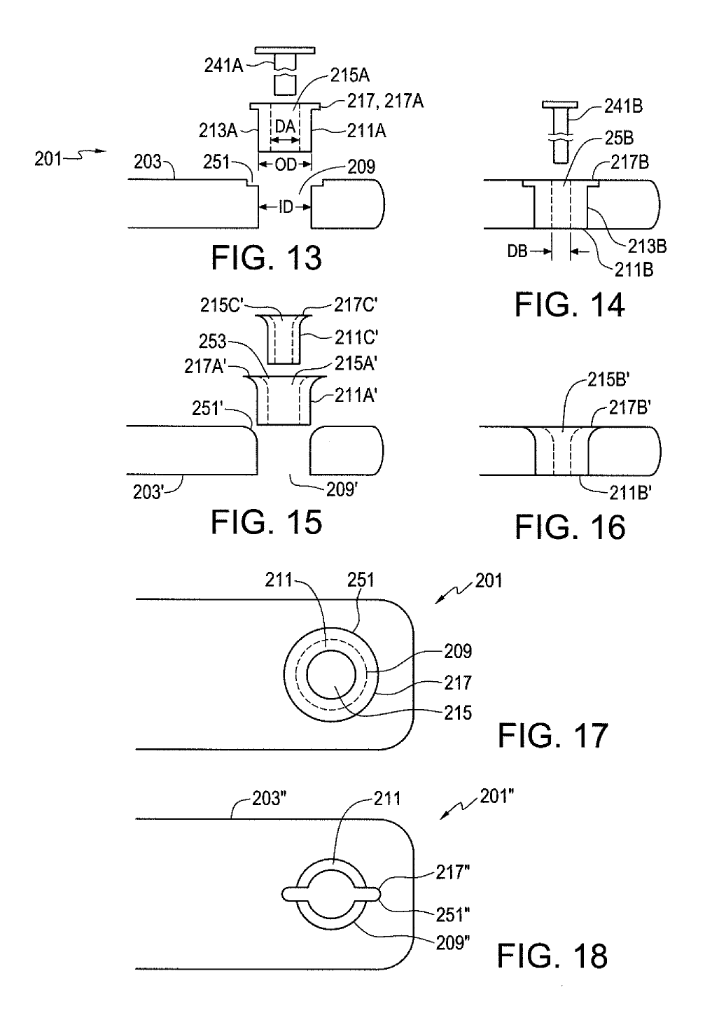

FIGS. 13 and 14 schematically illustrate a further hitch apparatus 201 for adapting the hole in a tongue member 203 to accommodate different sizes of drawpins. The apparatus 201 comprises a tongue member 203 defining a main drawpin hole 209 extending substantially vertically therethrough, such as is typical in a tongue member 203 provided by a tractor drawbar or implement hitch tongue.

A recess 251 is defined in the top surface of the tongue member 203 adjacent to the main drawpin hole 209. A first bushing 211A comprises a cylindrical portion 213A defining a first reduced drawpin hole 215A therethrough and having an outside diameter OD substantially equal to an inside diameter ID of the main drawpin hole 209 and a first flange portion 217A extending outward from a top end of the cylindrical portion 213A. FIG. 13 shows the bushing 211A above the bushing hole 209 and aligned to be inserted therein.

A second bushing 211B comprises a cylindrical portion 213B defining a second reduced drawpin hole 215B therethrough, the second reduced drawpin hole 215B having a diameter DB smaller than a diameter DA of the first reduced drawpin hole 215A, and having an outside diameter substantially equal to the inside diameter of the main drawpin hole 209 and a second flange portion 217B extending outward from a top end of the cylindrical portion 213B. FIG. 14 shows the bushing 211B inserted in the main drawpin hole 209.

One of the first and second bushings 211A, 211B is inserted into the main drawpin hole 209 and the corresponding first or second flange portion 217A, 217B, both of which are the same shape, substantially fills the recess 251 and keeps the bushing from falling through the main drawpin hole 209. The top surface of the tongue member 203 is kept substantially flat and unobstructed.

Thus either the first or second bushing 211A, 211B can be inserted into the main drawpin hole 209, and the bushing to be inserted is selected such that the diameter of the reduced drawpin hole, being either DA or DB in the selected bushing corresponds to a diameter of a selected drawpin 241A, 241B.

In the bushing of FIGS. 13, 14 the recess 215 and flanged portions 217 have square corners. FIGS. 15 and 16 schematically illustrate a tongue member 203′ and first and second bushings 211A′, 211B′ with flanges 217A′, 217B′ wherein sloping top portions of the main drawpin hole 209′ and reduced drawpin holes 215A′, 215B′ slope inward and downward from the top surface of the tongue member 203′, thus facilitating guiding the drawpin into the reduced drawpin holes 215A′, 215B′. The sloping top portion of the main drawpin hole 209′ provides the required recess 251′ to support the bushing 211A′. FIG. 15 shows the bushing 211A′ above the main drawpin hole 209′ and aligned to be inserted therein. FIG. 14 shows the bushing 211B′ inserted in the main drawpin hole 209′.

FIG. 15 also schematically illustrates changing the diameter of the drawpin hole by inserting a third bushing 211C′ into the reduced drawpin hole 215A′ in the first bushing 211A′. The third bushing 211C′ comprises a cylindrical portion defining a third reduced drawpin hole 215C′ therethrough and having an outside diameter substantially equal to the diameter of the first reduced drawpin hole 215A′ and a third flange portion 217C′ extending outward from a top end of the cylindrical portion 213C′ thereof into a recess 253 in a top surface of the first bushing 211A′ adjacent to the second drawpin hole 215A′. The recess 253 is provided by the sloping top portion of the first drawpin hole 215A′ and the correspondingly sloped flanged portion 217C′ substantially fills the recess 253.

FIG. 17 schematically illustrates a top view of an apparatus 201 wherein the recess 251 is substantially circular and concentric with the drawpin hole 215 of the inserted bushing 211. The flanged portion 217 of the bushing 211 fills the recess 251, and the bushing 211 is rotatable in the main drawpin hole 209.

FIG. 18 schematically illustrates a top view of an apparatus 201″ wherein the flanges 217″ engage the recess 251″ and prevent the bushing 211″ from rotating in the main drawpin hole 209″. The illustrated apparatus 211″ show the flanged portions 217 provided by tabs extending from the cylindrical portion of the bushing 211″ and filling corresponding recesses in the top of the tongue member 203″, however those skilled in the art will recognize that other configurations would provide the same function.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A hitch apparatus comprising:
a tongue member with a weight bearing surface and a free surface opposite the weight bearing surface, and defining a bushing hole extending substantially vertically therethrough from the weight bearing surface to the free surface;
a bushing comprising a cylindrical portion defining a drawpin hole therethrough and having an outside diameter substantially equal to an inside diameter of the bushing hole and a flange extending outward from one end of the cylindrical portion, the flange comprising a tongue surface adjacent to the cylindrical portion of the bushing, and an opposite wearing surface;
wherein the cylindrical portion of the bushing extends into the bushing hole such that the tongue surface of the flange bears against the weight bearing surface of the tongue member; and
wherein the bushing has a Rockwell Scale hardness greater than a Rockwell Scale hardness of the tongue member.

2. A connected hitch assembly comprising first and second hitch apparatuses according to claim 1, and wherein the wearing surface of the flange of the first hitch apparatus bears against the wearing surface of the second hitch apparatus.

3. The apparatus of claim 1 wherein the tongue member is an implement hitch tongue adapted at a rear end thereof for attachment to an implement to be towed in an operating travel direction, wherein the cylindrical portion of the bushing extends upward into the bushing hole, a top tongue surface of the flange bears against a bottom weight bearing surface of the tongue member, and the wearing surface of the flange faces downward.

4. The apparatus of claim 3 wherein a sloping top portion of the bushing hole slopes inward and downward from a top surface of the tongue member.

5. The apparatus of claim 4 wherein at least a portion of a bottom edge of the sloping top portion of the bushing hole aligns with an edge of the drawpin hole.

6. The apparatus of claim 5 wherein the sloping top portion of the bushing hole is curved.

7. The apparatus of claim 4 comprising a tapered groove extending from a rear bottom edge of the sloping top portion of the bushing hole rearward and upward to the top surface of the tongue member, and wherein a bottom portion of the tapered groove is wider than a top portion thereof.

8. The apparatus of claim 1 wherein the tongue member is a tractor drawbar adapted at a forward end thereof for attachment to a tractor for towing an implement in an operating travel direction, wherein the cylindrical portion of the bushing extends downward into the bushing hole, a bottom tongue surface of the flange bears against a top weight bearing surface of the tongue member, and the wearing surface of the flange faces upward.

9. The apparatus of claim 2 wherein:
the first hitch apparatus comprises an implement hitch tongue adapted at a rear end thereof for attachment to an implement to be towed in an operating travel direction, wherein the cylindrical portion of the bushing extends upward into the bushing hole, a top tongue surface of the flange bears against a bottom weight bearing surface of the tongue member, and the wearing surface of the flange faces downward;
the second hitch apparatus comprises a tractor drawbar adapted at a forward end thereof for attachment to a tractor for towing the implement, wherein the cylindrical portion of the bushing extends downward into the bushing hole, a bottom tongue surface of the flange bears against a top weight bearing surface of the tongue member, and the wearing surface of the flange faces upward; and
wherein the wearing surface of the flange of the implement hitch tongue rests on the wearing surface of the flange of the tractor drawbar and a drawpin extends through the drawpin holes of the flanges.

10. The apparatus of claim 1 wherein the Rockwell Scale hardness of the bushing is greater than about 60.

11. An implement hitch apparatus adapted at a rear end thereof for attachment to an implement to be towed in an operating travel direction, the apparatus comprising:
a hitch tongue member defining a hitch bushing hole extending substantially vertically through a front portion thereof;
a hitch bushing comprising a cylindrical portion defining a drawpin hole therethrough and having an outside diameter substantially equal to an inside diameter of the hitch bushing hole and a hitch flange extending outward from a bottom edge of the cylindrical portion;
wherein the cylindrical portion of the hitch bushing extends upward into the hitch bushing hole and a top surface of the hitch flange bears against a bottom surface of hitch tongue member; and
wherein the hitch bushing has a Rockwell Scale hardness greater than a Rockwell Scale hardness of the tongue member.

12. A connected tractor drawbar and implement hitch assembly configured for towing the implement with the tractor in an operating travel direction, the assembly comprising:
an implement hitch apparatus according to claim 11 attached at the rear end thereof to the implement;
a drawbar member attached at a front end thereof to a tractor and defining a drawbar bushing hole extending substantially vertically through a rear portion thereof;
a drawbar bushing comprising a cylindrical portion defining a drawpin hole therethrough and having an outside diameter substantially equal to an inside diameter of the drawbar bushing hole and a drawbar flange extending outward from a top edge of the cylindrical portion;
wherein the cylindrical portion of the drawbar bushing extends downward into the drawbar bushing hole and a bottom surface of the drawbar flange bears against a top surface of drawbar member;
wherein the drawbar bushing has a Rockwell Scale hardness greater than a Rockwell Scale hardness of the drawbar member; and
wherein the hitch tongue member is supported on the drawbar member with a bottom surface of the hitch flange bearing against a top surface of the drawbar flange, and a drawpin extends downward through the drawpin holes.

13. The apparatus of claim 12 further comprising a film of grease between the bottom wearing surface of the hitch flange and the top wearing surface of the drawbar flange.

14. The apparatus of claim 11 wherein the Rockwell Scale hardness of the hitch bushing is greater than about 60.

15. The apparatus of claim 12 wherein the hitch bushing and drawbar bushing have a Rockwell Scale hardness greater than a Rockwell Scale hardness of the drawpin.

16. The apparatus of claim 12 wherein the hitch tongue member is made from nodular cast iron.

17. A hitch apparatus comprising
a tongue member defining a main drawpin hole extending substantially vertically therethrough,
a recess defined in a top surface of the tongue member adjacent to the main drawpin hole;
a bushing comprising a cylindrical portion defining a reduced drawpin hole therethrough and having an outside diameter substantially equal to an inside diameter of the main drawpin hole and a flange portion extending outward from a top end of the cylindrical portion;
wherein the bushing is inserted into the bushing hole and the flange portion substantially fills the recess.

18. The apparatus of claim 17 comprising a first bushing comprising a cylindrical portion defining a first reduced drawpin hole therethrough, and a second bushing comprising a cylindrical portion defining a second reduced drawpin hole therethrough, the second reduced drawpin hole having a diameter smaller than a diameter of the first reduced drawpin hole, and having an outside diameter substantially equal to the inside diameter of the bushing hole, wherein each of the first and second bushings has a flange portion extending outward from a top end of the cylindrical portion thereof;
wherein one of the first and second bushings is inserted into the bushing hole and the flange portion thereof substantially fills the recess.

19. The apparatus of claim 18 further comprising a third bushing comprising a cylindrical portion defining a third reduced drawpin hole therethrough and having an outside diameter substantially equal to the diameter of the first reduced drawpin hole and a flange portion extending outward from a top end of the cylindrical portion thereof into a recess in a top surface of the first bushing adjacent to the first reduced drawpin hole.

20. The apparatus of claim 18 wherein the bushing to be inserted is selected such that the diameter of the drawpin hole in the selected bushing corresponds to a diameter of a selected drawpin.

21. The apparatus of claim 17 wherein the recess is substantially circular and concentric with the drawpin hole of the inserted bushing such that the bushing is rotatable in the main drawpin hole.

22. The apparatus of claim 17 wherein the flange portion engages the recess and prevent the bushing from rotating in the main drawpin hole.

23. The apparatus of claim 17 wherein a sloping top portion of the bushing hole slopes inward and downward from the top surface of the tongue member.

24. The apparatus of claim 17 comprising a hammer strap attached to the tongue member and extending over the main drawpin hole such that a gap is formed between a bottom of the hammer strap and a top of the tongue member, and wherein the hammer strap defines a substantially vertical strap hole aligned with the main drawpin hole, and wherein the strap hole has an inside diameter the same as the inside diameter substantially equal to the inside diameter of the main drawpin hole, and comprising:
a first drawpin adapted to extend through the aligned strap hole and reduced drawpin hole such that an upper portion thereof extending through the strap hole has an outside diameter substantially equal to the inside diameter of the main drawpin hole, and such that a lower portion thereof extending through the gap and the reduced drawpin hole has a diameter substantially equal to the inside diameter of the reduced drawpin hole; and
a second drawpin adapted to extend through the aligned strap hole and main drawpin hole such that an upper portion thereof extending through the strap hole and a lower portion thereof extending through the gap and the reduced drawpin hole has a diameter substantially equal to the inside diameter of the main drawpin hole.

25. The apparatus of claim 17 wherein the bushing has a Rockwell Scale hardness greater than a Rockwell Scale hardness of the tongue member.
